(19) United States
(12) Patent Application Publication
(10) Pub. No.: US 2016/0335067 A1
(43) Pub. Date: Nov. 17, 2016

(54) SOURCE CODE CUSTOMIZATION FRAMEWORK

(71) Applicant: Microsoft Technology Licensing, LLC, Redmond, WA (US)

(72) Inventor: Suriya Narayanan, Redmond, WA (US)

(21) Appl. No.: 14/708,483

(22) Filed: May 11, 2015

(51) Int. Cl. G06F 9/445

(52) U.S. Cl. CPC G06F 8/65

(57) ABSTRACT

An execution platform includes a processor configured to execute programmatic instructions. A storage device is coupled to the processor. An interface is configured to receive compiled software code in a software package and store the compiled software code in the storage device and to receive at least one compiled customization in a separate customization software package. The processor is configured to enumerate customizations in the separate customization software package and call at least one customized method indirectly.

### BACKGROUND

Computer systems are currently in wide use. Some such systems are customized (some significantly) before they are deployed at an end user's site. By way of example, some such computer systems include business systems, such as customer relations management (CRM) systems, enterprise resource planning (ERP) systems, line-of-business (LOB) systems, etc. In these types of systems, a general software system is first purchased by a user or customer, and the user or customer often makes customizations, extensions or other modifications to that general business system, in order to obtain their own customized deployment.

Typically, such customizations have been provided either through direct modification of the source code. Direct modification to source code provides the most flexibility for customization. With such modifications, any change can be made to the software. The limitation of this approach becomes apparent when the original software needs to be modified, such as when an update or patch is required. In such instances, the modifications to the original source code may no longer interoperate with various customizations. Thus, the developer must return to the modifications and carefully port or modify each of the previously-generated customizations to the updated/patched source code. In most cases, this manual and tedious process tends to require significant developer time and thus be very expensive.

The discussion above is merely provided for general background information and is not intended to be used as an aid in determining the scope of the claimed subject matter.

### SUMMARY

An execution platform includes a processor configured to execute programmatic instructions. A storage device is coupled to the processor. An interface is configured to receive compiled software code in a software package and store the compiled software code in the storage device and to receive at least one compiled customization in a separate customization software package. The processor is configured to enumerate customizations in the separate customization software package and call at least one customized method indirectly.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of an environment in which a developer provides customizations relative to original source code in accordance with an embodiment.

FIG. 2 is a diagrammatic view of a class diagram in accordance with one embodiment.

FIG. 3 is a flow diagram of a method of defining a customization relative to a defined type in source code.

FIG. 4 is a flow diagram of programmatic execution encountering a customization in accordance with one embodiment.

FIG. 5 shows pseudo-code illustrating a base method as well as a customization relative to the base method M1 and M2 that perform simple arithmetic operations.

FIG. 6A shows pseudo-code that modifies M1, while FIG. 6B shows pseudo-code that modifies M2.

FIG. 7 is a block diagram of the architecture shown in FIG. 1, except that some of its elements are deployed in a cloud computing architecture.

FIG. 8 is a simplified block diagram of one embodiment of a handheld or mobile computing device that can be used as a user's or client's hand held device, in which the present system (or parts of it) can be deployed.

FIG. 9 shows a mobile device in which embodiments of the present invention are useful.

FIG. 10 is a block diagram of one illustrative computing environment.

### DETAILED DESCRIPTION

In some computer programming languages, a “Type” is considered to be an abstraction, a concept that defines a set of operations on objects of that type and some state that is managed by the object. A class in programming languages such as C# is such an abstraction—the methods on a class are the operations and the private member variables of the class represent the state. In languages such as C#, the methods on the type and the state in the type are determined by the developer and are final once the type is compiled into an assembly. This regime is generally accepted in most cases, except when a consumer of the type—perhaps a customer or a partner wanting to use the type in their application or their type, realize that a change in one method would be necessary for them to effectively use the type. If the customer/partner has the source code of the original type accessible with the necessary licenses they could modify the type. Languages such as C# also offer the ability to mark a certain method virtual—indicating that the derived class can provide an alternate implementation of the method, and the actual method that is called is determined at runtime based on the actual type of the object at runtime. This requires the customer to understand the class hierarchy, which can often be complex and may not be perfect. Of course, this now generates a different problem in the context of an upgrade. If the original type were to be changed by the publisher in the future, it may or may not be compatible with the changes made by the customer/partner and it will be problematic for the customer/partner to reconcile the differences.

In some large software systems, such as an Enterprise Resource Planning application there may be a large collection of thousands such types. A type can be any one of a concept relevant to the application. For example, in a business such types may include a Sales order, Inventory of a product in a warehouse or an accounting transaction entry representing the allocation of money for a certain purpose, et cetera. A type can also be a class used to support development practices (such as integration with a version control system or a unit test class).

In general, there are two kinds of customizations that can be generated relative to an original software package in order to configure and/or further develop the software package for deployment. The first kind of customization is metadata customization, which includes, for example, changing the values of metadata properties—for example, the Label property of the Customer Table is changed from “Customer” to “Client.” The second kind of customization is code customization. An example of code customization is providing a different implementation of a method of a certain type. For instance, the method CalculateProfit in the SalesOrder type may be something that is desirable to change to a different implementation. Typically, changing an implementation would also require changing the state carried within the instances of that type. An additional challenge for code customization techniques is a trend to require fully-compiled code by the run-time environment, which is increasingly a shared server or cloud service. In such instances, runtime is purely running compiled code. If a method is ‘customized’ in this fashion, the entire assembly (for instance, the Application Suite) may need to be re-compiled—which is not always desirable.

Embodiments described herein generally leverage an existing software technique in a new way in order to provide customizable source code. The existing technique is known as extension classes. Extension classes are implemented in some languages, such as C# and X++, and are static methods that take as the first parameter an instance of a type. The compiler and development tools support calling these extension methods as if they are instance methods of the type. Even though these methods appear as instance methods, they can only access the public members of the type. Any member of the type that is declared private is still private. Extension classes are generally used to add an additional method to a class. Embodiments described herein leverage extension classes such that they may be used to implement an alternate method in place of an existing method in the run-time environment. Thus, extension classes, in accordance with embodiments described herein, are enhanced such that a method in an extension class is not just an additional method, but may be an alternate implementation of a method that already exist in the corresponding type.

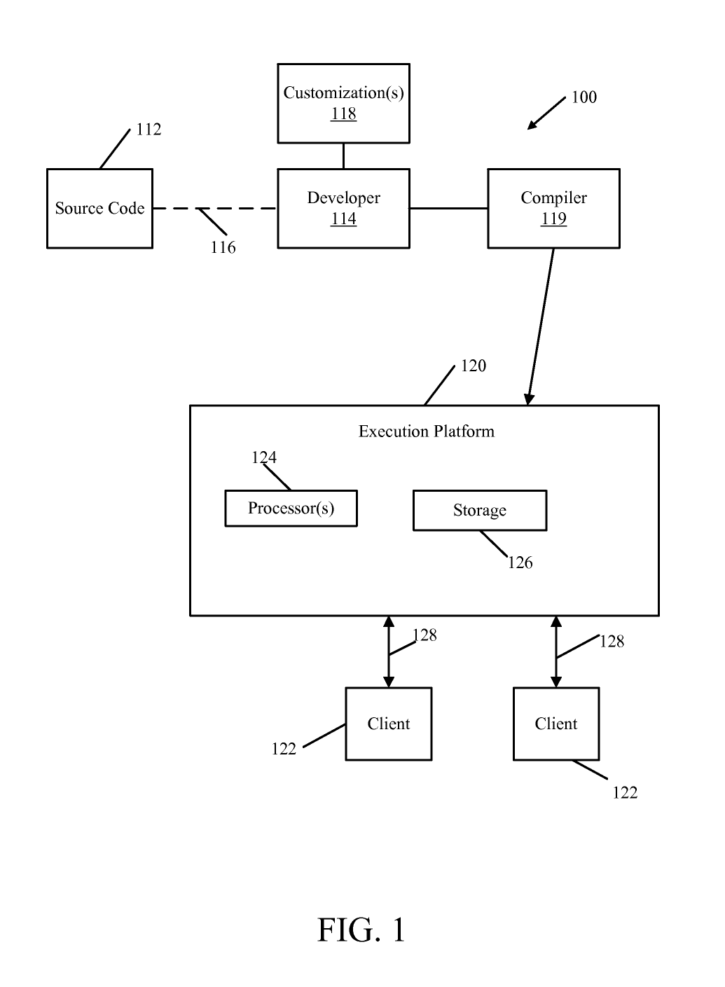

FIG. 1 is a diagrammatic view of an environment in which a developer 114 generates customizations relative to original source code 112. In environment 100, source code 12 has been obtained from a source code publisher, such as Microsoft Corporation. “Source code” as used herein is intended to mean a textual listing of commands that are to be compiled or assembled into a computer executable program. Source code can be provided in any of a number of now known or later developed programming languages. Typically, source code will be entered, line by line, by one or more authors of the software product.

As described above, many software products are intended to be customized before being deployed by an end user. One example of such as software product is an enterprise resource planning system. However, embodiments of the present invention are applicable whenever it is desirable to change the behavior of a software product without changing the source code of the software product. In the example shown in FIG. 1, developer 114 has access to source code 112 as indicated by dashed line 116. Certain public methods in classes of the source code 112 may be customizable. Each customizable method gets created with an attribute that is readable by compiler 119 such that the customizable method is called via a delegate during runtime. These customizations 118 are generally in the form of extension classes, as will be described in greater detail below. The customizations 118 are provided to compiler 119, which compiles the source code and extensions to generate machine-executable compiled code that is provided to execution platform 120. Execution platform 120 is any suitable arrangement of hardware, software or combination thereof that is capable of receiving and executing the compiled code. As such, execution platform 120 may be a single personal computer, a group of servers operating in an enterprise, a single core of a device, or a large group of servers operating in a cloud computing environment. Execution platform 120 may include one or more processors 124 as well as a suitable storage component 126 to support programmatic execution.

During run-time, execution platform 120 executes the compiled code along with customizations 118 to provide customized software operation to one or more clients 122 interacting with execution platform 120. Clients 122, in one example, are computers or mobile devices that are operably coupled to execution platform 120 via communication links 128 in order to allow clients 122 to interact with the software product being executed by execution platform 120. Links 128 can include any suitable communication links including wired or wireless communication through a LAN or WAN.

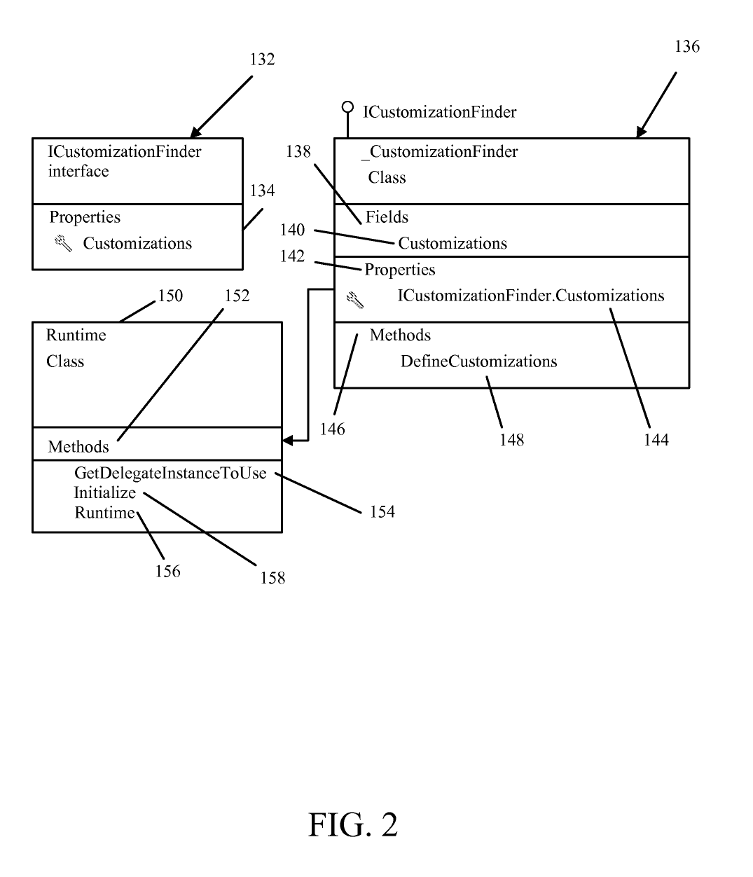

FIG. 2 is a diagrammatic view of a run-time class diagram in accordance with one embodiment. An interface 132 is provided to allow retrieval of the customizations 118 of the software package. Interface 132 may include a number of properties 134. Interface 132 is expected by the runtime execution platform that all customized packages implement. The compiler (or other development tool) is expected to provide an implementation of this interface at the time of compiling the source code containing customizations in the package. Additionally, a framework-generated class 136 is also provided. Class 136 includes a number of fields 138 relative to customizations 140. Further, class 136 includes properties 142 such as ICustomizationFinder.Customizations 144. Further still, class 136 includes a number of methods 146, such as DefineCustomizations method 148. Runtime class 150 represents the execution platform with a number of methods 152, such as GetDelegateInstanceToUse 154, Initialize 156 and Runtime 158. Execution platform 120 will, before a type with customizations is initialized, enumerate various customizable method delegates and initialize them using the runtime framework components. When more than one customization exists for the same method, the execution platform can determine, at runtime, which customized version gets called using any suitable logic or rule. The selection of the actual customized method is thus decoupled from the method itself.

Each package containing customizations has a framework generated class 136 to describe the customizations in that package. The framework generated class 136 implements interface 132 so that the run-time framework components can identify the customizations in the package. Upon initialization, the run-time enumerates the installed customization packages and decides which customizations are to be used. As the application runs, the run-time identifies the correct delegates (representing the customized methods) to use to call the methods as dictated by the customizations.

During run-time, each call to a customizable method is made indirectly via a delegate. In one embodiment, compiler 119 generates additional code for such calls. Additionally, some additional code generation is provided to support calling the base class methods from the derived class methods, when customized. The following is an example of how an automobile class may be customized in accordance with embodiments described herein.

```
          Class Automobile
          {
                Public virtual void Drive( )
                {
                Code
          }
          }
          Class Car:Automobile
          {
          public override void Drive( )
          {
          Code
          base.Drive( );
          }
          }
          Car.Drive( ) is customized - and that exists in a static extension class -
CarExtension. Accordingly:
    Static Class CarExtension
    {
        // this is the customized implementation of Car.Drive( )
        static void Drive_Extension (Automobile a)
        {
          // customized logic here...
          // Drive_Extension needs to call base.Drive( ) -
          // and this is not possible.
          // A technique is needed to call the base class method
          // (which itself may be customized).
          // the embodiment has a mechanism for exposing the
          // delegate instances - this can be surfaced in the language
          // via a suitable construct - so the compiler can translate
          // the construct into the right code...
          // For example, something like.
```

| | |
|---|---|
| revised_base.Drive (...) | // indicates it should call the base class method, |
| | //where revised_base is a language keyword that |
| | //the compiler recognizes to mean that a base |
| | //class implementation of the corresponding |
| | //derived class method should be called |
| } | |
| } | |

In the above example, base.Drive( ) could not be called since this current class is a static class. Instead, an alternate invocation of the base class implementation of Drive is provided. In the Automobile class, which itself may be customized, the ability to call the base class implementation of a method is surfaced via a language keyword, such as “customizedBase” which compiler 119 translates into the right code, “revised_Base.Drive( ).”

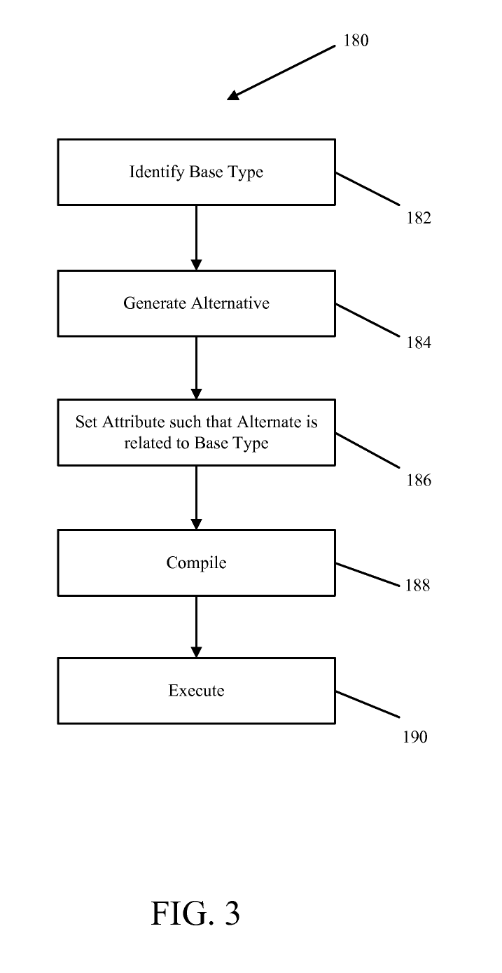

FIG. 3 is a flow diagram of a method of defining a customization relative to a defined type in source code 12. Method 180 begins at block 182 where a developer identifies a base type to be customized. Next, at block 184, the developer creates an alternate method for the base type. In one embodiment, this alternate method may be defined using an extension class. At block 186, the developer generates an indication that the alternate method is a customization of a method in the base type. This can be done by setting any suitable parameter of the alternate method. At block 188, a compiler, such as compiler 119, reads the parameter indicative of the extension method and generates code for calling the customizable method via a delegate. At run-time, the code is executed, as indicated at block 190.

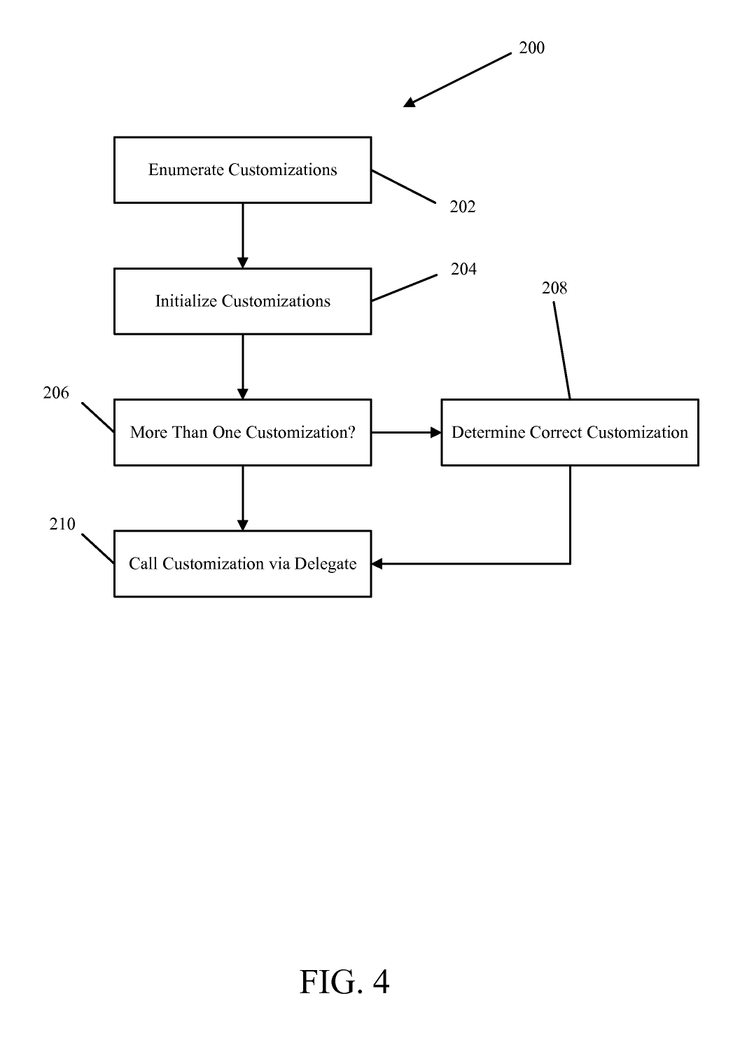

FIG. 4 is a flow diagram of programmatic execution encountering a customization in accordance with one embodiment. Method 200 begins at block 202 where an execution platform, such as platform 120, enumerates all of the customizations of a software package. Next, at block 204, all of the enumerated customizations are initialized by the execution platform. At block 206, the execution platform determines if more than one customization exists for a given base method. If no more than one customization exists for a given base method, then control passes to block 210, wherein the execution platform calls the customization via a delegate. However, if block 206 determines that more than one customization exists for a given base method, then control passes to block 208 where the execution platform determines the correct customization to invoke. This determination can be done in accordance with any suitable logic or condition provided to the execution platform, as desired. Once the correct customization has been determined, control passes to block 210 where the correct customization is called by the execution platform via a delegate.

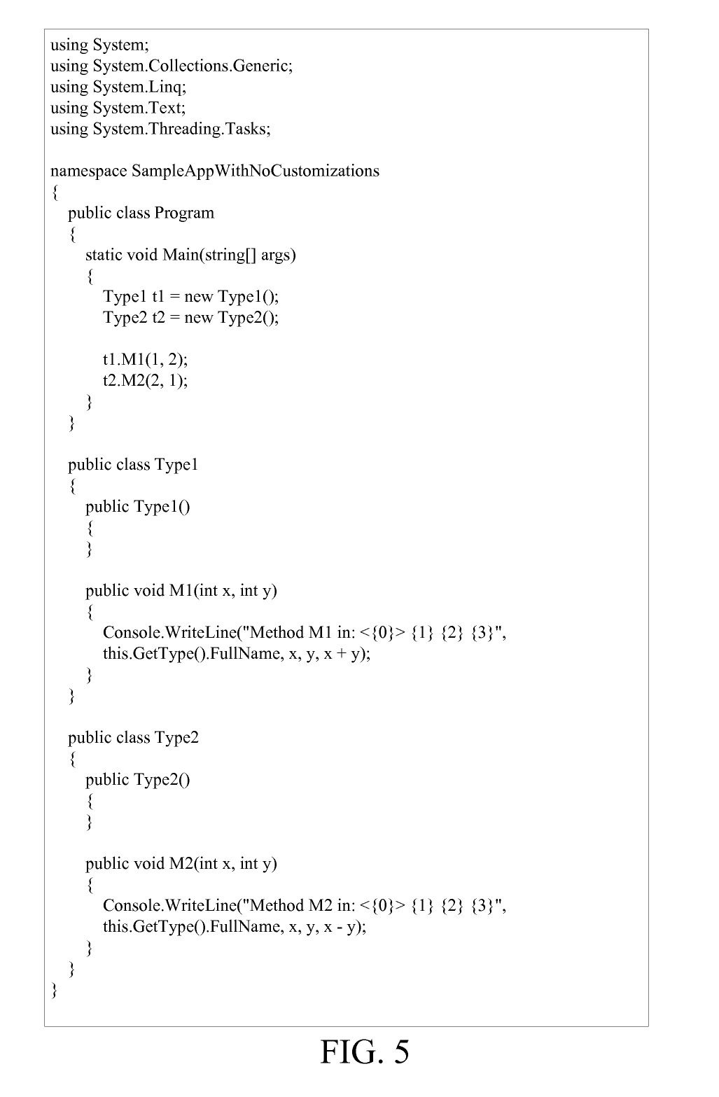

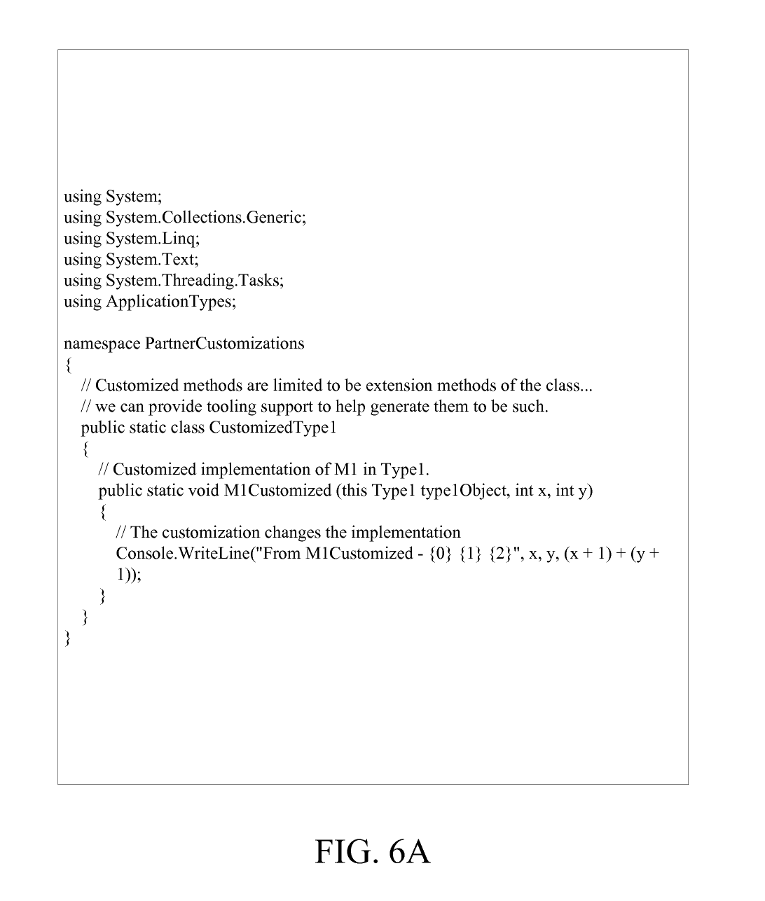

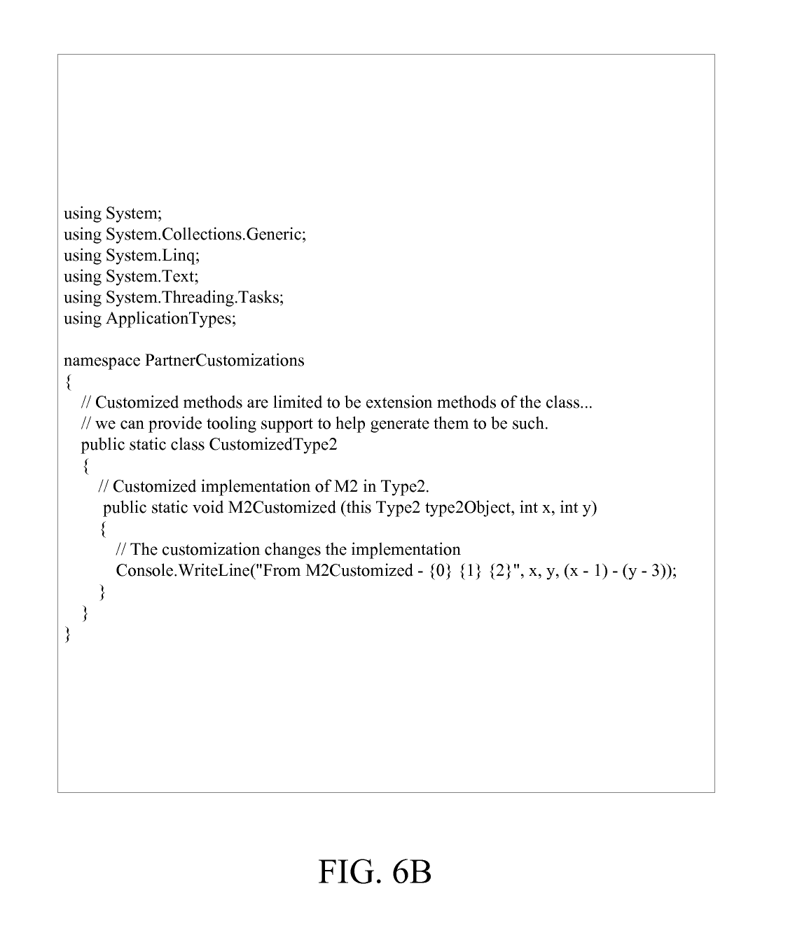

FIG. 5 shows pseudo-code illustrating a base method as well as a customization relative to the base method M1 and M2 that perform simple arithmetic operations. FIG. 6A shows pseudo-code that modifies M1, while FIG. 6B shows pseudo-code that modifies M2.

Embodiments described herein provide a number of useful features. For example, embodiments provide alternate implementations of methods in types without having to recompile the type. Thus, a compiled software package can be operating on an execution platform and a compiled alternate version of a method that exists in the alternate compiled software package can be provided to the execution platform and run in place of the original method. This is very useful in that the entire software package need not be re-compiled to include the alternate method. While this idea is described in the context of source code customizations, the idea is applicable in other areas such as patching as well.

Embodiments described herein also allow the customizations to be run in separate environments or “sandboxed” if desired. In some software implementations, when a developer or customer provided a different implementation of a method, the developer's method code runs in the same process space as the rest of the code provided by software manufacturer. The developer's customization may or may not be trusted fully to run in a shared operating environment. If the customer is hosting and operating the instance of the software package and managing it, the customer is responsible for the code and operations. On the other hand, if the customization were deployed in a cloud operational environment, operated by Microsoft or other application providers, the impact of an error in the developer's customization could be widespread. In such shared operational environments, it would be advisable to run the customization in a ‘sandbox’ instance with possible reduced privileges and increased control and monitoring. Embodiments described here enable the ability to sandbox—because the customization code and the original code that was customized are indeed compiled into different assemblies. The run time framework can be enhanced to provide sandboxing.

An additional feature provided by embodiments described herein is that additional metadata for the customization itself can be used by the execution platform various purposes. Since the customization itself is packaged as a separate assembly, it is possible to attach additional metadata in the form of attributes. Such metadata can describe anything—such as different rules or conditions to be met in order to activate the customization at runtime, billing and monetization policies that the customization expects, et cetera.

Providing the customization(s) in a separate compiled software package from the original software package also provides the ability to allow the customization to be authored in a different programming language than the original method. Supporting additional languages (supporting the .net framework) for expressing customizations. Traditionally, code customizations have been written in the same language as the original application code. However, using embodiments described herein this no longer needs to be the case. Since customizations are modeled as extension classes and x++ is compiled into .net IL, the customization extension class could be in another .net language (such as C# or VB.net). Of course, some common interfacing requirements are still required so that the common patterns for applications are available from both languages.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

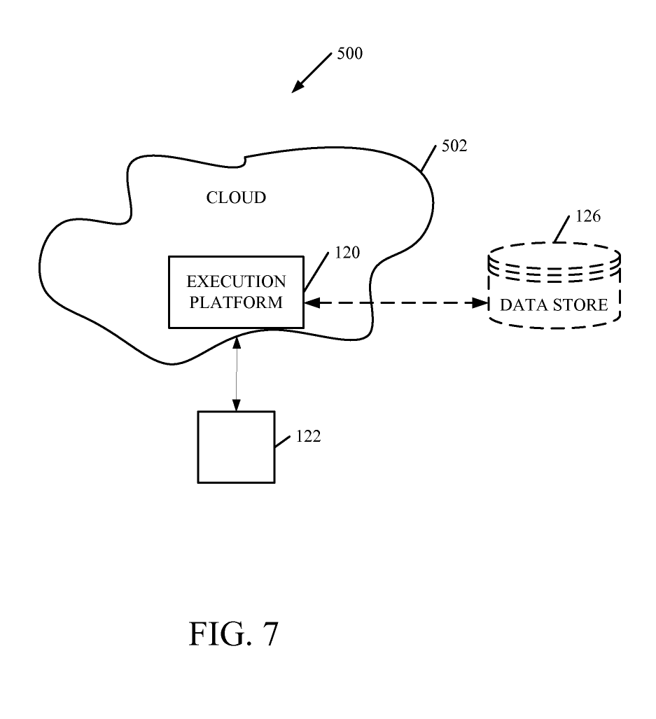

FIG. 7 is a block diagram of architecture 100, shown in FIG. 1, except that some of its elements are deployed in a cloud computing architecture 500. The term “cloud”, “cloud-based system”, “cloud-based architecture”, or similar terms refer to a network of devices (e.g. server computers, routers, etc.). Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 7, some items are similar to those shown in FIG. 1 and they are similarly numbered. FIG. 7 specifically shows that execution platform 120 can be located in cloud 502 (which can be public, private, or a combination where portions are public while others are private). Therefore, the user uses a client device 122 to access those systems through cloud 502.

FIG. 7 also depicts another embodiment of a cloud architecture. FIG. 7 shows that it is also contemplated that some elements of architecture 100 are disposed in cloud 502 while others are not. By way of example, data store 126 can be disposed outside of cloud 502, and accessed through cloud 502. Regardless of where they are located, they can be accessed directly by client device 22, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be employed on a wide variety of different devices. Some of those devices include servers, desktop computers, laptop computers, tablet computers, or other mobile devices, such as palm top computers, cell phones, smart phones, multimedia players, personal digital assistants, et cetera.

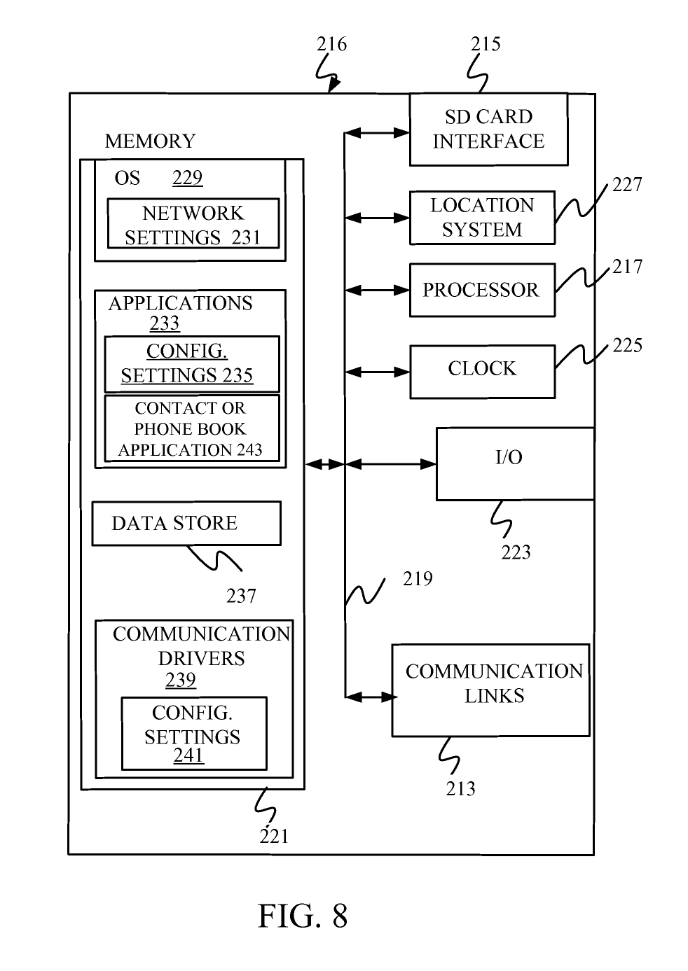

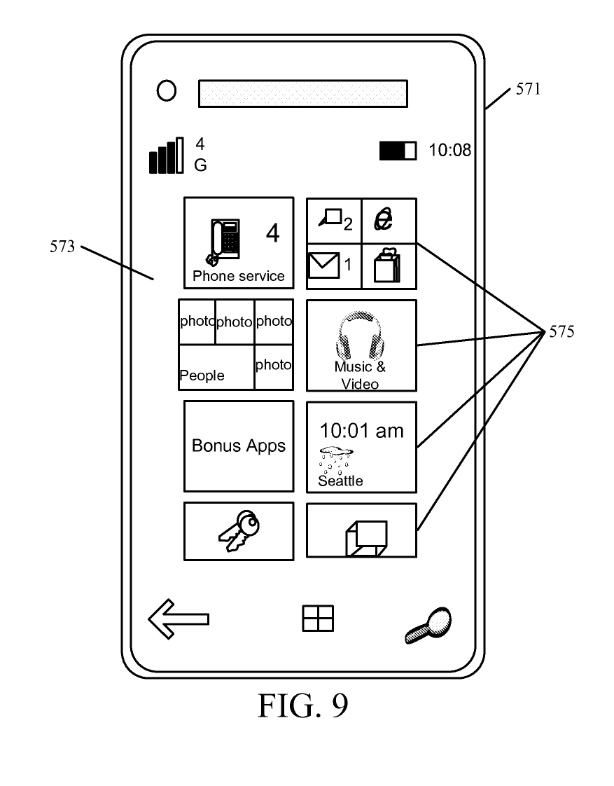

FIG. 8 is a simplified block diagram of one embodiment of a handheld or mobile computing device that can be used as a user's or client's hand held device 216, in which the present system (or parts of it) can be deployed. FIG. 9 depicts another examples of a handheld or mobile device.

FIG. 8 provides a general block diagram of the components of a client device 216 that can run components of architecture 100 or that interacts with architecture 100. In device 216, a communications link 213 is provided that allows the handheld device to communicate with other computing devices and under some embodiments provides a channel for receiving information automatically, such as by scanning. Examples of communications link 213 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

According to other embodiments, applications or systems are received on a removable Secure Digital (SD) card that is connected to a SD card interface 215. SD card interface 215 and communication links 213 communicate with a processor 217 along a bus 219 that is also connected to memory 221 and input/output (I/O) components 223, as well as clock 225 and location system 227.

I/O components 223, in one embodiment, are provided to facilitate input and output operations. I/O components 223 for various embodiments of the device 216 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 223 can be used as well.

Clock 225 illustratively comprises a real time clock component that outputs a time and date. It can also, illustratively, provide timing functions for processor 217.

Location system 227 illustratively includes a component that outputs a current geographical location of device 216. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 221 stores operating system 229, network settings 231, applications 233, application configuration settings 235, data store 237, communication drivers 239, and communication configuration settings 241. Memory 221 can include all types of tangible volatile and non-volatile computer-readable memory devices. It can also include computer storage media (described below). Memory 221 stores computer readable instructions that, when executed by processor 217, cause the processor to perform computer-implemented steps or functions according to the instructions. Processor 217 can be activated by other components to facilitate their functionality as well.

Examples of the network settings 231 include things such as proxy information, Internet connection information, and mappings. Application configuration settings 235 include settings that tailor the application for a specific enterprise or user. Communication configuration settings 241 provide parameters for communicating with other computers and include items such as GPRS parameters, SMS parameters, connection user names and passwords.

Applications 233 can be applications that have previously been stored on the device 216 or applications that are installed during use, although these can be part of operating system 229, or hosted external to device 216, as well.

FIG. 9 is a diagrammatic view of a smart phone 571, with which embodiments may be practiced. Smart phone 571 has a touch sensitive display 573 that displays icons or tiles or other user input mechanisms 575. Mechanisms 575 can be used by a user to run applications, make calls, perform data transfer operations, et cetera. In general, smart phone 571 is built on a mobile operating system and offers more advanced computing capability and connectivity than a feature phone

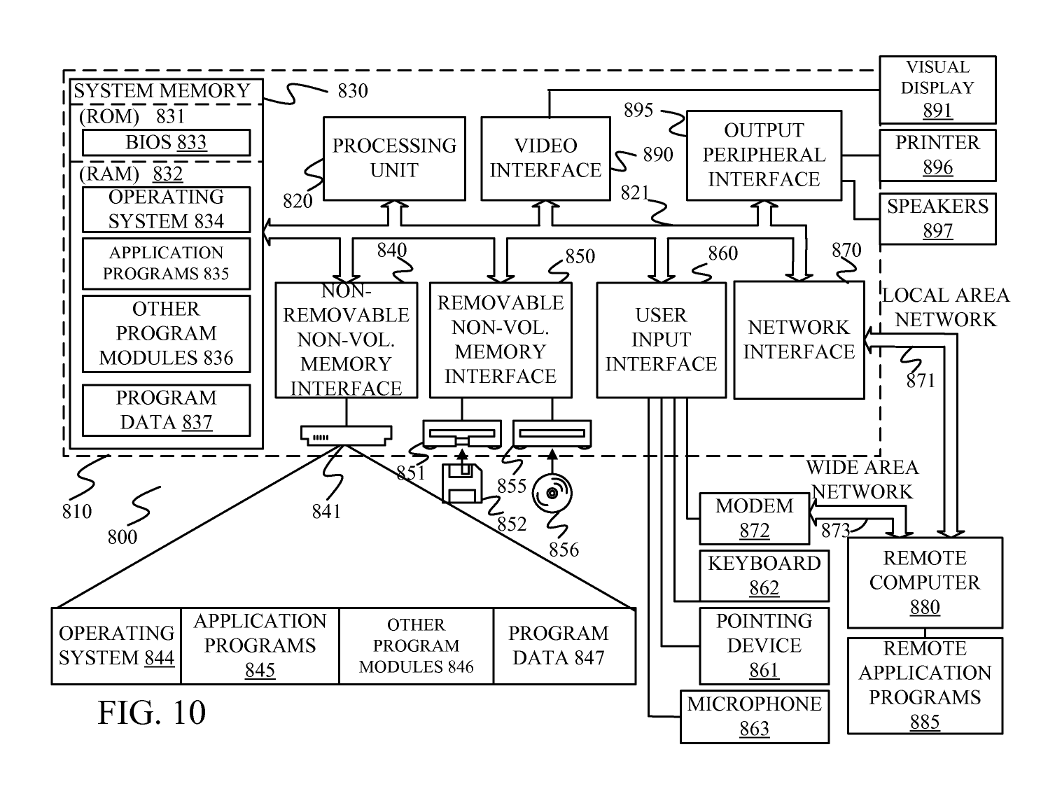

FIG. 10 is one embodiment of a computing environment in which architecture 100, or parts of it, (for example) can be deployed. For example, the computing environment may be used for compiler 119 and/or execution platform 120. With reference to FIG. 10, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is an execution platform that includes a processor configured to execute programmatic instructions. A storage device is coupled to the processor. An interface is configured to receive compiled software code in a software package and store the compiled software code in the storage device and to receive at least one compiled customization in a separate customization software package. The processor is configured to enumerate customizations in the separate customization software package and call at least one customized method indirectly.

Example 2 is the execution platform of any or all previous examples wherein the processor is configured to make each indirect call to a customized method via a delegate.

Example 3 is the execution platform of any or all previous examples wherein the processor is configured to interact with a framework-generated class in the separate customization software package to enumerate customizations.

Example 4 is the execution platform of any or all previous examples wherein the framework-generated class includes an interface through which the customizations are enumerated.

Example 5 is the execution platform of any or all previous examples wherein the framework-generated class includes a runtime class having at least one method.

Example 6 is the execution platform of any or all previous examples wherein the at least one method includes a method that obtains a delegate to use for the customization.

Example 7 is the execution platform of any or all previous examples wherein the at least one method includes an initialization method.

Example 8 is the execution platform of any or all previous examples wherein the processor is further configured to determine which customization to call among a plurality of available customizations that apply to a single base method.

Example 9 is the execution platform of any or all previous examples wherein the customization has access to methods of the base type for which the at least one customization applies.

Example 10 is the execution platform of any or all previous examples wherein the processor is configured to execute the at least one customization in a sandbox execution environment.

Example 11 is a computer-implemented method of generating a customization relative to a base type in a first software package. The method includes identifying the base type for which a customization will be executable. Source code is received defining the customization. An attribute is set that relates the customization to the base method. The received source code is compiled into a second software package.

Example 12 is the method of any or all previous examples wherein the customization has access to method of the base type.

Example 13 is the method of any or all previous examples wherein the first and second source packages are separate.

Example 14 is the method of any or all previous examples wherein the received source code is in a different language than source code that was compiled into the first software package.

Example 15 is the method of any or all previous examples and further comprising providing the compiled first and second software packages to an execution platform.

Example 16 is a method of executing compiled software. The method includes enumerating at least one customization relative to the compiled software. At least one customization is initialized. A customization is selected to call relative to a base method. The customization is called indirectly.

Example 17 is the method of any or all previous examples wherein selecting a customization to call relative to the base method includes determining a correct customization among a plurality of customization relative to the base method.

Example 18 is the method of any or all previous examples wherein the customization is called via a delegate.

Example 19 is the method of any or all previous examples wherein the customization is executed in a sandbox computing environment.

Example 20 is the method of any or all previous examples wherein the at least one customization is enumerated via an interface of a framework-generated class in a compiled software package containing the at least one customization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An execution platform comprising:
a processor configured to execute programmatic instructions;
a storage device coupled to the processor;
an interface configured to receive compiled software code in a software package and store the compiled software code in the storage device and to receive a compiled customization in a separate customization software package:
wherein the processor is configured to enumerate a customization in the separate customization software package and call a customized method indirectly via a delegate.

2. (canceled)

3. The execution platform of claim 1, wherein the processor is configured to interact with a framework-generated class in the separate customization software package to enumerate the customization.

4. The execution platform of claim 3, wherein the framework-generated class includes an interface through which the customization is enumerated.

5. The execution platform of claim 3, wherein the framework-generated class includes a runtime class having at least one method.

6. The execution platform of claim 5, wherein the at least one method includes a method that obtains a delegate to use for the customization.

7. The execution platform of claim 5, therein the at least one method includes an initialization method.

8. The execution platform of claim 3, wherein the processor is further configured to determine which customization to call among a plurality of available customizations that apply to a single base method.

9. The execution platform of claim 1, wherein the customization has access to methods of the base type for which the customization applies.

10. The execution platform of claim 1, wherein the processor is configured to execute the customization in a sandbox execution environment.

11. A computer-implemented method of generating a customization relative to a base type in a first software package, the method comprising:
identifying the base type for which a customization will be executable;
receiving source code defining the customization wherein the received source code is in a different language than source code that was compiled into the first software package;
setting an attribute that relates the customization to the base method; and
using a compiler to compile the received source code into a second software package.

12. The computer-implemented method of claim 11, wherein the customization has access to method of the base type.

13. The computer-implemented method of claim 11, wherein the first and second source packages are separate.

14. (canceled)

15. The computer-implemented method of claim 11, and further comprising providing the compiled first and second software packages to an execution platform.

16. A computer-implemented method of executing compiled software, the method comprising:
enumerating at least one customization relative to the compiled software;
initializing the at least one customization;
selecting a correct customization to call among a plurality of customizations relative to a base method;
calling the customization indirectly via a delegate.

17. (canceled)

18. (canceled)

19. The computer-implemented method of claim 16, wherein the customization is executed in a sandbox computing environment.

20. The computer-implemented method of claim 16, wherein the at least one customization is enumerated via an interface of a framework-generated class in a compiled software package containing the at least one customization.

21. The execution platform of claim 1, wherein the customization customizes a general computing system to a customized deployment.

22. The execution platform of claim 1, wherein the processor is configured to call the customized method indirectly by using an extension class.

23. The execution platform of claim 1, wherein the delegate is a method that takes an instance of a type.
